(19) United States
(12) Patent Application Publication
(10) Pub. No.: US 2011/0278819 A1
(43) Pub. Date: Nov. 17, 2011

(54) KICKSTAND LOAD BEARING SYSTEM

(76) Inventor: Garry Segal, Hendersonville, NC (US)

(21) Appl. No.: 12/779,142

(22) Filed: May 13, 2010

(51) Int. Cl. B62H 7/00

(52) U.S. Cl. 280/293

(57) ABSTRACT

A kickstand load bearing system is provided that includes a load-spreading base, the load-spreading base being operable to receive a load imposed thereon by a kickstand of a wheeled vehicle, an extendable handle, and an articulating connector. The articulating connector mounts the extendable handle to the load-spreading base for articulated movement of the extendable handle relative to the load-spreading base for articulated movement of the extendable handle relative to the load-spreading base in a manner that permits a movement of the extendable handle relative to the load-spreading base about a tilt axis, a yaw axis perpendicular to the tilt axis, and a slew axis perpendicular to the tilt axis and the yaw axis.

### BACKGROUND OF THE INVENTION

The present invention relates to kickstand load bearing system for use with a two wheeled vehicle having a kickstand.

According to U.S. Pat. No. 7,267,353, a motorcycle or other two-wheel vehicle conventionally is equipped with a kickstand located at one lower side of the vehicle so as to be movable by the rider's foot from a raised or retracted position to a lowered, extended position in which it supports the motorcycle. The kickstand has a supporting arm which, in the extended position, projects downwardly and laterally and is of such length that, when the free end engages the ground or paved surface at ground level, the motorcycle may assume a generally upright condition which will be maintained by the kickstand, thereby enabling the rider to park and leave the motorcycle. Conventionally, the kickstand arm is of such length that, when the vehicle is in its parked condition, the motorcycle is not vertical, but is inclined or tilted toward that side of the vehicle on which the kickstand is mounted. This minimizes the possibility that the motorcycle will fall toward the opposite side.

In those instances in which the free end of the extended kickstand arm engages unpaved ground or pavement, such as asphalt, particularly on a hot day, the free end of the kickstand arm may become embedded with the result that the center of gravity of the vehicle moves so far toward the side on which the kickstand is mounted that the motorcycle falls. Even if the motorcycle does not fall, the embedding of the kickstand arm is objectionable for a number of reasons.

Some motorcycles have such a substantial weight that, should they fall, the rider may be unable to restore the motorcycle to an upright condition without assistance. In some instances, assistance is not readily available so the rider of a fallen motorcycle may be unable to return the motorcycle to a usable position for an extended period of time. Regardless of whether a rider may return a fallen motorcycle to a usable position, either with or without assistance, the falling of a motorcycle is undesirable because one of more parts of the vehicle may be damaged.

The disadvantages of the consequences of embedding the free end of a kickstand arm in soft ground or pavement have been recognized heretofore. One proposal to minimize embedding the kickstand arm is to provide a portable support which may be placed on the ground or pavement in a position between the ground and the free end of the kickstand arm. The support is formed of a material of such strength and area as to provide a rigid support for the kickstand arm. In use, the portable support is placed on the ground in such position that the free end of the kickstand may contact the support, thereby enabling the rider to park the vehicle even though the ground or pavement at the parking site is soft.

When such a portable support is used and the rider returns to the parked vehicle, it is customary for the rider to move the vehicle from its tilted, parked condition to a more upright position thereby enabling the portable support to be retrieved. When this occurs, however, the rider is in an awkward position during the retrieval of the support as a result of which here is a possibility that the rider will be unable to prevent falling of the motorcycle. This possibility is enhanced in those instances in which the rider may be astride the motorcycle and must lean over to such an extent as to grasp the portable support.

Thus, there continues to be a need for a kickstand support pad system that ameliorates the above-noted drawbacks while offering greater convenience and deployment ease to a motorcycle operator.

### SUMMARY OF THE INVENTION

According to one aspect of the present invention, there is provided a kickstand load bearing system which includes a load-spreading base. The load-spreading base is configured to be carried by a user. An extendable handle is also included. The extendable handle includes a user engagement element which is at a spacing from the articulating connector in a riser direction perpendicular to the lateral direction. An articulating connector is also provided. The extendable handle is mounted to the load-spreading base by the articulating connector for articulated movement of the extendable handle relative to the load-spreading base. The load-spreading base is connected to the articulating connector at a base connection location and the extendable handle is connected to the articulating connector at a flip down location. The articulating connector mounts the extendable handle to the load-spreading base for articulated movement of the extendable handle relative to the load-spreading base in a manner that permits movement of the extendable handle relative to the load-spreading base about a tilt axis perpendicular to the lateral direction and the riser direction and parallel to a riser plane, movement of the extendable handle relative to the load-spreading base about a yaw axis perpendicular to the riser plane and the tilt axis, and movement of the extendable handle relative to the load-spreading base about an slew axis parallel to the riser plane and perpendicular to the tilt axis and the yaw axis.

In accordance with a further feature of the one aspect of the present invention, the extendable handle includes an indicia bearing structure.

In accordance with a further additional feature of the one aspect of the present invention, the extendable handle includes an indicia bearing structure in the form of a pennant or flag.

In accordance with yet a further additional feature of the one aspect of the present invention, the load-spreading base is comprised of at least one of an elastomer, a rubber material, or a plastic.

In accordance with another further additional feature of the one aspect of the present invention, the articulating connector includes a spherical receiving cap, the handle includes a spherically shaped bottom portion correspondingly configured with respect to the spherical receiving cap of the articulating connector, the spherically shaped bottom portion of the handle is received in the spherical cup of the articulating connector in a manner that permits limited movement of the handle about the tilt axis, the yaw axis, and the slew axis while retaining the spherically shaped bottom portion of the handle in a seated disposition on the spherical cup of the articulating connector.

In accordance with yet another further additional feature of the one aspect of the present invention, the load spreading base includes a through bore and the articulating connector includes a mounting sleeve disposable in a friction fit in the through bore of the load spreading base.

In accordance with a further additional feature of the one aspect of the present invention, the articulating connector includes a ball glide retainer that partially overlies the spherically shaped bottom portion of the handle and a coil spring for resiliently biasing the spherically shaped bottom portion of the handle against the ball glide retainer.

### BRIEF DESCRIPTION OF THE DRAWINGS

An embodiment of the present invention is hereinafter described with reference to the figures of the drawings as follows:

FIG. 1 is a perspective view of one embodiment of the kickstand load bearing system of the present invention;

FIG. 2 is a perspective view of the one embodiment of the kickstand load bearing system of the present invention shown in use with a motorcycle kickstand;

FIG. 3 is an enlarged front elevational view in partial section of a portion of the base and the hinge of the one embodiment of the kickstand load bearing system of the present invention;

FIG. 4 is a perspective view of the one embodiment of the kickstand load bearing system of the present invention in its collapsed for carry disposition;

FIG. 5 is a perspective view of the handle of another embodiment of the kickstand load bearing system of the present invention in the fully extended position of the handle;

FIG. 6 is a perspective view of the handle of the another embodiment of the kickstand load bearing system of the present invention in the fully retracted position of the handle; and

FIG. 7 is a perspective schematic view of the one embodiment of the kickstand load bearing system of the present invention with reference to an axis reference system.

### DETAILED DESCRIPTION OF THE PREFERRED EMBODIMENT

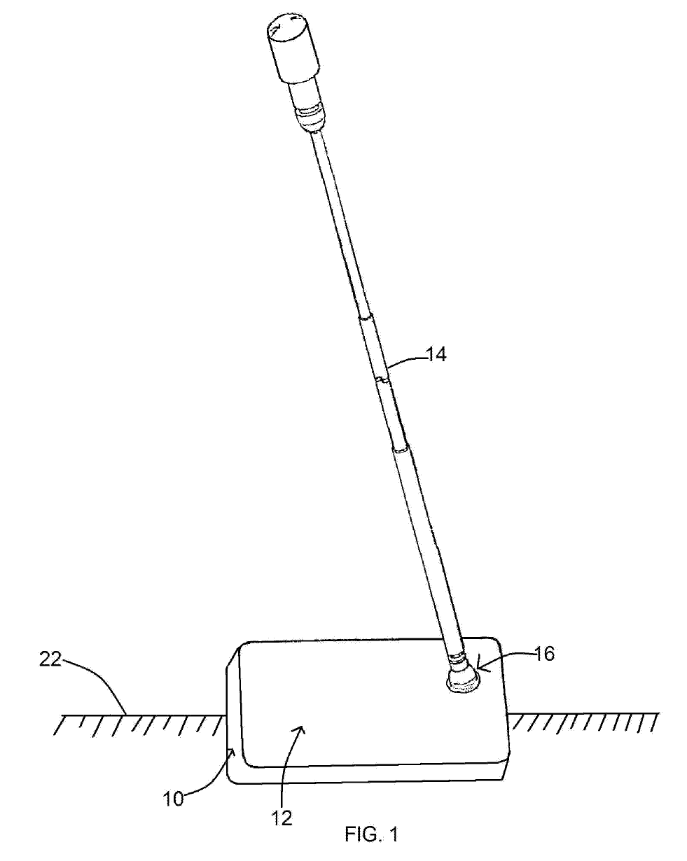

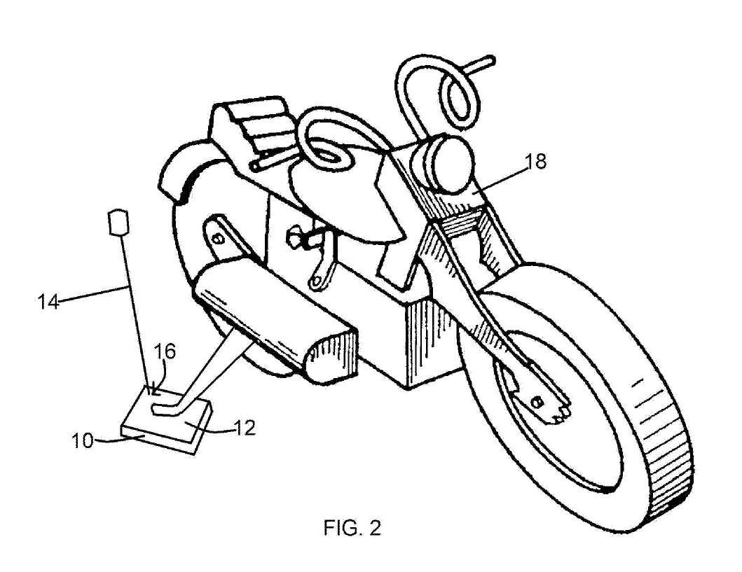

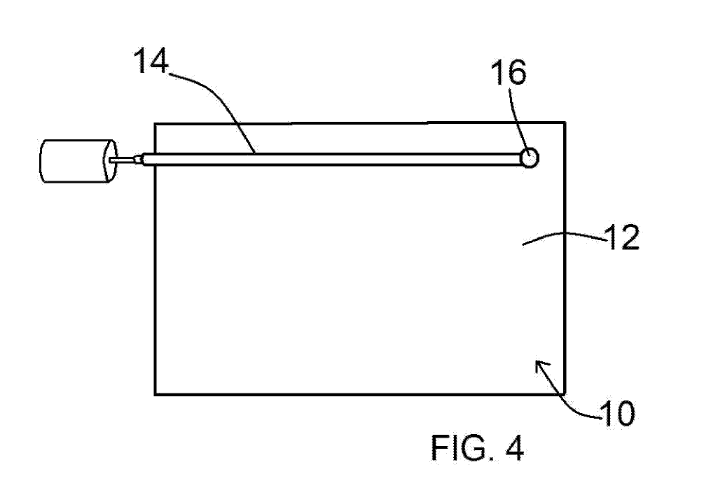

As seen in FIGS. 1-4, one embodiment of the kickstand load bearing system of the present invention is generally designated as the kickstand load bearing system 10 and includes a load-spreading 12, an extendable handle 14, and an articulating connector 16. The load-spreading base 12 is configured to be carried by a user, such as, for example, a two wheeled vehicle operator operating a motorcycle 18, as seen in FIG. 2.

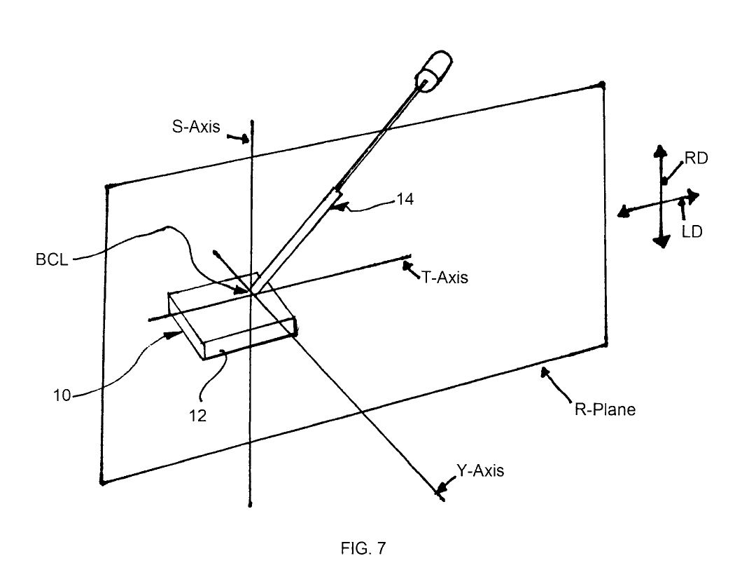

The articulating connector 16 mounts the extendable handle 14 to the load-spreading base 12 for articulated movement of the extendable handle 14 relative to the load-spreading base 12. As seen in FIG. 7, which is a perspective schematic view of the one embodiment of the kickstand load bearing system of the present invention with reference to a axis reference system, the load-spreading base 12 and the articulating connector 16 are coupled to one another at a base connection location and the extendable handle 14 is connected to the articulating connector 16 at a flip down location BCL.

A riser plane R-Plane passes through the articulating connector 16 and is perpendicular to the lateral direction LD and the riser plane R-Plane passes through the flip down location BCL. The articulating connector 16 mounts the extendable handle 14 to the load-spreading 12 for articulated movement of the extendable handle 14 relative to the load-spreading 12 in a manner permitting movement of the extendable handle 14 relative to the load-spreading 12 about a tilt axis T-Line perpendicular to the lateral direction LD and the riser direction RD and parallel to the riser plane R-Plane, movement of the extendable handle 14 relative to the load-spreading base 12 about a yaw axis Y-Line perpendicular to the riser plane R-Plane and the tilt axis T-Line, and movement of the extendable handle 14 relative to the load-spreading base 12 about a slew axis S-Line parallel to the riser plane R-Plane and perpendicular to the tilt axis T-Line and the yaw axis Y-Line.

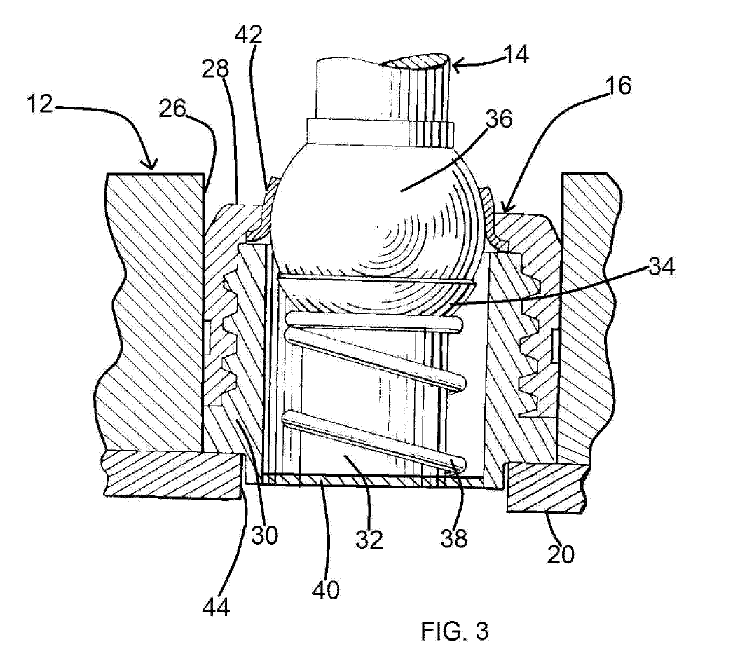

As seen FIG. 1, which is a perspective view of the kickstand load bearing system 10 in its deployed condition, the load-spreading base 12 is configured to rest with its underside surface 20 (seen in FIG. 3) on a ground surface such as, for example, an asphalt surface 22. The handle 14, which, as seen in FIG. 1, is extendable into a full extension disposition, extends at an upward angle relative to the load-spreading base 12. With the kickstand load bearing system 10 in its deployed condition as shown, a kickstand 24 of the motorcycle 18, as seen in FIG. 2, can be placed upon the load-spreading base 12 so that the load-spreading base 12 acts as an intermediate support element between the lower extent of the kickstand 24 and the asphalt surface 22. As will be described in greater detail, the configuration of the load-spreading base 12 including its material properties make the load-spreading base 12 a suitable intermediate support element that, among other benefits, prevents the kickstand 24 of the motorcycle 18 from detrimentally penetrating into the asphalt surface 22. Additionally, the load-spreading base 12 provides a safety benefit in that the motorcycle operator can reliably park the motorcycle 18 at a selected location on the asphalt surface 22 without fear that an inadvertent movement or penetration of the kickstand 24 into the asphalt surface will lead to the motorcycle 18 tipping over.

With reference now to FIG. 3, which is an enlarged perspective view in partial section of a portion of the load-spreading base 12 and a portion of the handle 14, as well as a full view of the pivot 16, the operation of the handle 14 relative to the load-spreading base 12 will now be described.

As seen in FIG. 3, the hinge 16 is configured to be received in a through bore 26 provided in the load-spreading base 12 correspondingly configured for receiving the hinge 16. The hinge 16 permits movement of the handle 14 about the tilt, yaw, and lateral axes while the handle 14 is reliably fixedly mounted relative to the load-spreading base 12. The hinge 16 includes a mounting sleeve 28 having an annular outer surface at a diameter slightly larger than the diameter of the through bore 26 of the load-spreading base 12. Thus, the mounting sleeve 28 of the hinge 16 can be snuggly inserted into the through bore 26 of the load-spreading base 12—that is, inserted under pressure so as to be retained by friction and compression by the walls of the through bore 26 of the load-spreading base 12. The mounting sleeve 28 of the hinge 16 is provided with a threaded inner bore and the hinge 16 includes a thread insert 30 having an outer threaded surface correspondingly threaded with respect to the inner threaded surface of the mounting sleeve 28 such that the insert 30 can be threadably secured into the mounting sleeve 28.

The insert sleeve 30 has a hollow cylindrical core and a pedestal 32 is disposed within the hollow core of the mounting sleeve 30. The pedestal 32 has an open-faced receiving cup 34 that is correspondingly configured with respect to a spherical bottom portion 36 of the handle 14 for receiving the spherical bottom portion partially seated therein. A coil spring 38 is disposed around the pedestal 32 and an upper axial end of the coil spring 38 is in contact with, and restrained by, a rim on the pedestal 32 extending around the base of the receiving cup 34. A lower axial end of the coil spring 38 is in contact with, and restrained by, a covered disk 40 that is secured to the lower axial end of the hollow inner bore of the insert sleeve 30. The pedestal 32 has a lower axial end that is in contact with the disk 40. A ball glide retainer 42, preferably comprised of hard rubber, has a lower annular edge that is secured between the mounting sleeve 28 and the threaded insert 30 and has an extent that tapers from a diameter generally equal to the diameter of the spherical bottom portion 36 of the handle 14 to a diameter of a lesser value.

In the final assembled condition of the hinge 16 within the load-spreading base 12, the mounting sleeve 28 has been inserted into the through bore 26 of the load-spreading base 12 to be snuggly received therein. The covered disk 40 of the hinge 16 preferably lies slightly above the lower surface 20 of the load-spreading base 12. The threadable insert 30, at its lower axial rim, rests upon an appropriate retaining element such as, for example, a shoulder rim extension 44 of the load-spreading base 12 that extends radially inwardly under the threadable insert 30. The spherical bottom portion 36 of the handle 14 is preferably pre-assembled into its seated position on the receiving cup 34 of the pedestal 32 prior to the insertion of the mounting sleeve 28 of the hinge 16 into the through bore 26 of the load-spreading base 12. In this pre-assembled condition, the spherical bottom portion 36 of the handle 16 is restrained by the ball glide retainer 42, whereupon upward axial movement of the handle 14 is resisted. As can be understood, the coil spring 38 applies an upward axial force against the receiving cup 34 of the pedestal 32 so as to thereby urge the handle 14 in an axial upward direction. However, as noted, the ball glide retainer 42 resists upward axial movement beyond a predetermined limit yet permits movement of the spherical bottom portion 36 of the handle 14 relative to the receiving cup 34 and the ball glide retainer 42 as the handle 14 is tilted about its various axes. The handle 14 readily permits the two wheeled vehicle operator to conveniently extend the handle to its full extent so as thereafter position the load-spreading base 12 on the asphalt surface 22 and to conveniently retract the handle and thereafter lodge the retracted handle into the retention clip on the load-spreading base 12 when the operator is preparing to stand the two wheeled vehicle in an upright position.

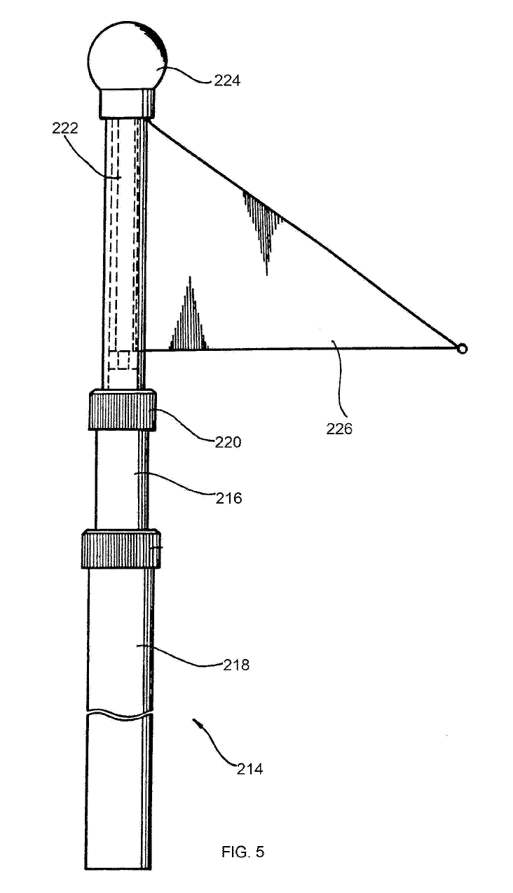

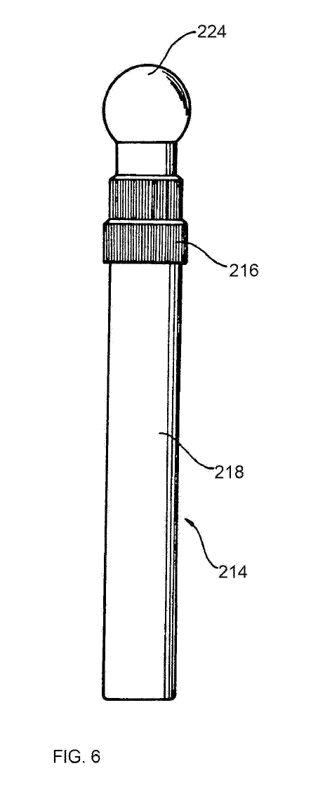

As seen in FIGS. 5 and 6, another embodiment of the kickstand load bearing system 10 advantageously provides the additional feature of signaling means or advertising means. As seen in FIG. 5, which is an enlarged front elevational view of a portion of the handle of the kickstand load bearing system 10 of this other embodiment, the handle, generally designated as the handle 214, includes a small diameter pole tube 216 and a large diameter pole tube 218 that slideably receives the small diameter pole tube 216. The upper end of the small diameter pole tube 216 and the upper end of the large diameter pole tube 218 each have a male-threaded portion provided with a vertical split gap. Complimentary-threaded rings 220 are threadably received on the male-threaded portions of the pole tubes 216, 218 and rotation of the complimentary-threaded rings 220 in a selected clockwise or counter clockwise direction effects either a constricting action in which the vertical split gap of the respective pole tube is narrowed in its width or is permitted to expand from a constricted narrow width to its nominal width, whereby the small diameter pole tube 216 can be releasably secured in the large diameter pole tube 218 by appropriate clockwise or counter clockwise rotation of the complimentary-threaded ring 220 of the large diameter pole tube 218. Conversely, upon appropriate rotation of the complimentary-threaded ring 220 of the large diameter pole tube 218, the small diameter pole tube 216 can be slideably extended from the large diameter pole tube 218 and, upon being extended into its full extension position, this small diameter pole tube 216 can be retained in its full extension position by rotation of the complimentary-threaded ring 220 of the large diameter pole tube 218 to effect a constriction of the upper end of the large diameter pole tube 218 that compressively engages a lower portion of the small diameter pole tube 216.

A pennant tube 222 has a diameter correspondingly configured relative to the small diameter of pole tube 216 such that the pennant tube 222 can be slideably retracted into and extracted out of the small diameter pole tube 216. The pennant tube 222 is capped by a rotatable cap 224 and the large end of a triangular shaped pennant 226 is secured to the longitudinal extent of the pennant tube 222. The cap 224 can be gripped so that the pennant tube 222 can be rotated about its axis relative to the small diameter pole tube 216 to thereby affect a furling up or an unfurling of the pennant 226. With the pennant 226 completely furled around the pennant tube 222, the pennant tube 222 can be pushed into the small diameter pole tube 216 and secured therein via appropriate rotation of the complimentary threaded ring 220 of the small diameter pole tube 216. FIG. 6 illustrates the pennant tube 222 fully received into pole tube 216 and the small diameter pole tube 216 fully received in the large diameter pole tube 218, whereby it can be understood that the collapsed disposition of the handle 214 shown in FIG. 6 has a substantially smaller overall height than the height of the handle 214 in the pennant deployed position shown in FIG. 5.

It can therefore be understood that the kickstand load bearing system 10 of the present invention is very convenient and provides a readily assessable structure that a two wheeled vehicle operator operating a two wheeled vehicle having a kickstand such as, for example, a motorcycle operator, can easily deploy to provide an intermediate support structure between the kickstand and the surface such as the asphalt or soil surface upon which the two wheeled vehicle rests. Additionally, it can be provided that the kickstand load bearing system 10 has a capability that facilitates its ready storage on the two wheeled vehicle. In this regard, suitable releasable attachment structures such as, for example, textile hook-and-loop material (i.e., Velcro (registered trademark) brand fastening strips), rubber bands, rope and string ties, tie wraps, and bolt mountings having complimentary structures on the two wheeled vehicle and the kickstand load bearing system 10, can be provided.

With regard to the display indicia, such indicia can be placed on the pennant 226 and can include suitable advertising text or graphics, team or association affiliation text and graphics, and other conventional pennant adorning indicia. In addition to, or as an alternative to, such pennant indicia, the handle 14 can be provided with reflective material or light emitting elements both to facilitate ready identification of the kickstand load bearing system 10 when stored on a two wheeled vehicle as well as to provide a light enhancing capability that facilitates the identification of the handle 14 when the kickstand load bearing system 10 has been deployed in its kickstand support disposition. Also, the top of the handle 14 can be configured with a suitable grab grip that improves the grasping of the handle during deployment of the kickstand load bearing system 10. Such a grab grip can be made of reflective material such as light reflective polymers or rubbers or can be provided with a separate reflective strip wrapped therearound. Also, the grab grip can be provided with display indicia in the form of ornamental top depicting a character, object, or text such as, for example, an “eight-ball” graphic depiction, a “skull” graphic depiction, or a cartoon character.

The kickstand load bearing system 10 can also be provided with a suitable releasable clip appropriately located on the top surface of the load-spreading base 12 for releasably receiving the handle 14 when the handle has been disposed in its fully retracted position and tilted so as to be substantially parallel to the top surface of the load-spreading base 12.

While an embodiment of the invention has been described and illustrated herein, it is to be distinctly understood that the invention is not limited thereto, but may be otherwise variously embodied and practiced within the scope of the following claims.

1. A kickstand load bearing system, comprising:
a load-spreading base, the load-spreading base being operable to receive a load imposed thereon by a kickstand of a wheeled vehicle and the load spreading-base having a load receiving portion for engagement by a kickstand of a wheeled vehicle;
an extendable handle; and
an articulating connector, the articulating connector mounting the extendable handle to the load-spreading base for articulated movement of the extendable handle relative to the load-spreading base, the articulating connector being secured to the load-spreading base at a base connection location, the base connection location being separate from the load receiving portion of the load-spreading base that engages a kickstand of a wheeled vehicle, the articulating connector mounting the extendable handle to the load-spreading base for articulated movement of the extendable handle relative to the load-spreading base in a manner that permits a movement of the extendable handle relative to the load-spreading base about a tilt axis, a movement of the extendable handle relative to the load-spreading base about a yaw axis perpendicular to the tilt axis, and a movement of the extendable handle relative to the load-spreading base about a slew axis perpendicular to the tilt axis and the yaw axis, and the articulating connector permitting a movement of the extendable handle relative to the load-spreading base about the tilt, yaw, and slew axes independent of any fixed or moving engagement of the load receiving portion of the load-spreading base and a kickstand of a wheeled vehicle.

2. The kickstand load bearing system according to claim 1, wherein the extendable handle includes an indicia bearing structure.

3. The kickstand load bearing system according to claim 2, wherein the extendable handle includes an indicia bearing structure in the form of a pennant or flag.

4. The kickstand load bearing system according to claim 1, wherein the load-spreading base is configured as a selected one of a round, parallelepiped, or oblong shaped structure.

5. The kickstand load bearing system according to claim 4, wherein the load-spreading base is comprised of at least one of an elastomer, a rubber material, or a plastic.

6. The kickstand load bearing system according to claim 1, wherein the articulating connector includes a spherical receiving cap, the handle includes a spherically shaped bottom portion correspondingly configured with respect to the spherical receiving cap of the articulating connector, the spherically shaped bottom portion of the handle is received in the spherical cup of the articulating connector in a manner that permits limited movement of the handle about the tilt axis, the yaw axis, and the slew axis while retaining the spherically shaped bottom portion of the handle in a seated disposition on the spherical cup of the articulating connector.

7. The kickstand load bearing system according to claim 6, wherein the load spreading base includes a through bore and the articulating connector includes a mounting sleeve disposable in a friction fit in the through bore of the load spreading base.

8. The kickstand load bearing system according to claim 7, wherein the articulating connector includes a ball glide retainer that partially overlies the spherically shaped bottom portion of the handle and a coil spring for resiliently biasing the spherically shaped bottom portion of the handle against the ball glide retainer.

9. A kickstand load bearing system, comprising:
a load-spreading base, the load-spreading base being operable to receive a load imposed thereon by a kickstand of a wheeled vehicle and the load spreading-base having a load receiving portion for engagement by a kickstand of a wheeled vehicle;
an extendable handle, the extendable handle including an indicia bearing structure; and
an articulating connector, the articulating connector mounting the extendable handle to the load-spreading base for articulated movement of the extendable handle relative to the load-spreading base, the articulating connector being secured to the load-spreading base at a base connection location, the base connection location being separate from the load receiving portion of the load-spreading base that engages a kickstand of a wheeled vehicle, the articulating connector mounting the extendable handle to the load-spreading base for articulated movement of the extendable handle relative to the load-spreading base in a manner that permits a movement of the extendable handle relative to the load-spreading base about a tilt axis, a movement of the extendable handle relative to the load-spreading base about a yaw axis perpendicular to the tilt axis, and a movement of the extendable handle relative to the load-spreading base about a slew axis perpendicular to the tilt axis and the yaw axis, and the articulating connector permitting a movement of the extendable handle relative to the load-spreading base about the tilt, yaw, and slew axes independent of any fixed or moving engagement of the load receiving portion of the load-spreading base and a kickstand of a wheeled vehicle.
